(19) United States
(12) Patent Application Publication
(10) Pub. No.: US 2021/0271230 A1
(43) Pub. Date: Sep. 2, 2021

(54) METHOD AND DEVICE FOR CONTROLLING MACHINE EQUIPMENT, AND STORAGE MEDIUM

(71) Applicant: Shanghai SenseTime Lingang Intelligent Technology Co., Ltd., Shanghai (CN)

(72) Inventors: Shenghong GENG, Shanghai (CN); Yuzhu ZOU, Shanghai (CN); Feng DING, Shanghai (CN); Jun WU, Shanghai (CN)

(21) Appl. No.: 17/326,446

(22) Filed: May 21, 2021

Related U.S. Application Data
(63) Continuation of application No. PCT/CN2019/112007, filed on Oct. 18, 2019.

(30) Foreign Application Priority Data
Sep. 24, 2019 (CN) 201910907653.0

(51) Int. Cl. G05B 19/418

(52) U.S. Cl. CPC G05B 19/4185; G05B 19/41815; G05B 2219/24015; G05B 2219/23178; G05B 19/41835

(57) ABSTRACT

Provided are a method and device for controlling machine equipment, and a storage medium. The method is as follows. A first communication mode supported by the machine equipment is determined. Of at least one candidate interface preset for communicating with the machine equipment, a first target interface corresponding to the first communication mode is determined. A target program is sent to the machine equipment by calling the first target interface.

### CROSS-REFERENCE TO RELATED APPLICATIONS

This application is a continuation of International Application No. PCT/CN2019/112007, filed on Oct. 18, 2019, which per se is based on, and claims benefit of priority to, Chinese Application No. 201910907653.0, filed on Sep. 24, 2019. The disclosures of International Application No. PCT/CN2019/112007 and Chinese Application No. 201910907653.0 are hereby incorporated by reference in their entireties.

### TECHNICAL FIELD

The present disclosure relates to the field of machine equipment control, and more particularly, to a method and device for controlling machine equipment, and a storage medium.

### BACKGROUND

With development of artificial intelligence, machine equipment control and programming education have gradually become an important part of K12 (Kindergarten through twelfth grade) education. Especially for online programming education, due to a sandbox mechanism of a browser in an online environment where each application has a corresponding sandbox and an application cannot access a sandbox other than the sandbox corresponding to the application per se, there are many restrictions on controlling machine equipment through an online experiment platform.

Taking an online programming platform being a makecode application as an example, the online programming platform will generate a binary file for machine equipment, and save the binary file in a computer. A student has to connect the machine equipment to the computer, copy the binary file to a specified directory of the machine equipment, and then start the machine equipment to run a programming result.

### SUMMARY

The present disclosure provides a method and device for controlling machine equipment, and a storage medium.

According to an aspect of embodiments of the present disclosure, there is provided a method for controlling machine equipment. The method includes: determining a first communication mode supported by the machine equipment; determining, of at least one candidate interface preset for communicating with the machine equipment, a first target interface corresponding to the first communication mode; and sending a target program to the machine equipment by calling the first target interface. In the embodiment, the terminal may automatically send the target program to the machine equipment, which simplifies the operation process of sending the target program to the machine equipment, and reduces the manual operation when controlling the machine equipment through the target program.

According to an aspect of embodiments of the present disclosure, there is provided a method for controlling machine equipment, including: receiving a target program sent by a terminal through a first target interface, the first target interface being an interface of at least one candidate interface preset for communicating with the machine equipment determined by the terminal according to a first communication mode supported by the machine equipment; and executing the target program. In the embodiment, the machine equipment may directly receive the target program sent by the terminal through the first target interface, thereby executing the target program, which simplifies the operation of acquiring the target program.

According to an aspect of embodiments of the present disclosure, there is provided a device for controlling machine equipment, including: a first determining module configured to determine a first communication mode supported by the machine equipment; a second determining module configured to determine, of at least one candidate interface preset for communicating with the machine equipment, a first target interface corresponding to the first communication mode; and a first sending module configured to send a target program to the machine equipment by calling the first target interface.

According to an aspect of embodiments of the present disclosure, there is provided a device for controlling machine equipment, including: a receiving module configured to receive a target program sent by a terminal through a first target interface, the first target interface being an interface of at least one candidate interface preset for communicating with the machine equipment determined by the terminal according to a first communication mode supported by the machine equipment; and an executing module configured to execute the target program.

According to an aspect of embodiments of the present disclosure, there is provided a non-transitory computer-readable storage medium, having stored thereon a computer program for implementing any foregoing method for controlling machine equipment.

According to an aspect of embodiments of the present disclosure, there is provided a device for controlling machine equipment, including: a processor; and a memory for storing executable instructions executable by the processor. The processor is configured to call the executable instructions stored in the memory to implement any foregoing method for controlling machine equipment.

It should be understood that the general description above and the elaboration below are exemplary and explanatory only, and do not limit the present disclosure.

### BRIEF DESCRIPTION OF THE DRAWINGS

Drawings here are incorporated in and constitute part of the specification, illustrate embodiments in accordance with the present disclosure, and together with the specification, serve to explain the principle of the present disclosure.

FIG. 1 is a flowchart of a method for controlling machine equipment according to an embodiment of the present disclosure.

FIG. 2 is a diagram of a scene of trigger of calling a first target interface according to an embodiment of the present disclosure.

FIG. 3 is a flowchart of another method for controlling machine equipment according to an embodiment of the present disclosure.

FIG. 4 is a diagram of a scene of setting a second target interface according to an embodiment of the present disclosure.

FIG. 5 is a flowchart of another method for controlling machine equipment according to an embodiment of the present disclosure.

FIG. 6 is a flowchart of another method for controlling machine equipment according to an embodiment of the present disclosure.

FIG. 7 is a flowchart of another method for controlling machine equipment according to an embodiment of the present disclosure.

FIG. 8 is a flowchart of another method for controlling machine equipment according to an embodiment of the present disclosure.

FIG. 9 is a flowchart of another method for controlling machine equipment according to an embodiment of the present disclosure.

FIG. 10 is a flowchart of another method for controlling machine equipment according to an embodiment of the present disclosure.

FIG. 11 is a diagram of a scene of controlling machine equipment according to an embodiment of the present disclosure.

FIG. 12 is a block diagram of a device for controlling machine equipment according to an embodiment of the present disclosure.

FIG. 13 is a block diagram of another device for controlling machine equipment according to an embodiment of the present disclosure.

FIG. 14 is a block diagram of another device for controlling machine equipment according to an embodiment of the present disclosure.

FIG. 15 is a block diagram of another device for controlling machine equipment according to an embodiment of the present disclosure.

FIG. 16 is a block diagram of another device for controlling machine equipment according to an embodiment of the present disclosure.

FIG. 17 is a block diagram of another device for controlling machine equipment according to an embodiment of the present disclosure.

### DETAILED DESCRIPTION

Exemplary embodiments (examples of which are illustrated in the drawings) are elaborated below. The following description refers to the drawings, in which identical or similar elements in two drawings are denoted by identical reference numerals unless indicated otherwise. Implementations set forth in the following exemplary embodiments do not represent all implementations in accordance with the present disclosure. Rather, they are mere examples of the device and method in accordance with certain aspects of the present disclosure as recited in the claims.

Terms used in the present disclosure are for describing specific embodiments instead of limiting the present disclosure. Singulars “a/an”, “said” and “the” used in the present disclosure and the appended claims are intended to include the plural form, unless expressly illustrated otherwise by context. The term “and/or” used in the present disclosure refers to and includes any or all possible combinations of one or more associated items listed.

Note that although a term such as first, second, third may be adopted in an embodiment herein to describe various kinds of information, such information should not be limited to such a term. Such a term is merely for distinguishing information of the same type. For example, without departing from the scope of embodiments of the present disclosure, the first information may also be referred to as the second information. Similarly, the second information may also be referred to as the first information. Depending on the context, a term “if” as used herein may be interpreted as “when” or “while” or “in response to determining that”.

Embodiments of the present disclosure provide a method for controlling machine equipment, which may be used in a terminal. Optionally, the terminal may be electronic equipment that may run a programming client (such as a makecode application, etc.), such as a mobile phone, a laptop, a computer, or a tablet, etc. Machine equipment may be electronic equipment that performs an action or operation corresponding to a computer program, such as a robot that may perform an operation such as raising a hand, raising a leg, or saying hello, etc., according to an online programmed target program, or a drone, an unmanned vehicle, etc. The method may also be executed by way of a processor running a computer-executable code.

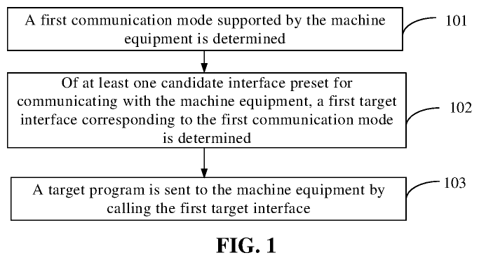

Refer to FIG. 1. FIG. 1 is a method for controlling machine equipment according to an exemplary embodiment, including steps as follows. In step 101, a first communication mode supported by the machine equipment is determined.

In some embodiments of the present disclosure, the first communication mode may include, but is not limited to, a User Datagram Protocol (UDP), a Web Socket, a Socket Input/Output (Socket IO), a Bluetooth, a serial port, etc.

Different machine equipment may support the same communication mode or different first communication modes. One piece of machine equipment may support at least one first communication mode. For example, certain machine equipment supports a Socket IO communication mode, while other machine equipment supports UDP and Socket IO communication modes.

After detecting that the machine equipment is connected to the terminal, the terminal may acquire equipment information of the machine equipment, and determine the first communication mode supported by the machine equipment based on the equipment information of the machine equipment. The equipment information of the machine equipment may include the equipment type, manufacturer, equipment identification, etc., of the machine equipment.

In some embodiments of the present disclosure, optionally, the terminal may also determine the first communication mode supported by the machine equipment according to the detection mode in which the machine equipment is detected. For example, if the terminal scans the machine equipment through Bluetooth, the terminal may determine that the first communication mode supported by the machine equipment is Bluetooth.

In step 102, of at least one candidate interface preset for communicating with the machine equipment, a first target interface corresponding to the first communication mode is determined.

In some embodiments of the present disclosure, a preset application may abstract at least one candidate interface from different first communication modes for access by multiple pieces of hardware. A candidate interface may communicate with machine equipment supporting different first communication modes. The at least one candidate interface may include a sending interface, for sending information to machine equipment, and a monitoring interface, for monitoring information sent by machine equipment. The preset application may be a preset application configured to provide an abstract interface for communicating with different machine equipment. The preset application may establish a service-independent communication channel between a programming client and machine equipment.

In this step, the terminal may determine, in the at least one candidate interface, a sending interface corresponding to the first communication mode supported by currently detected machine equipment, and take the sending interface as the first target interface.

For example, if the first communication mode supported by detected machine equipment is UDP, the first target interface is a UDP sending interface. Alternatively, if the first communication mode supported by detected machine equipment is Web Socket, then the first target interface is a Web Socket sending interface.

In step 103, a target program is sent to the machine equipment by calling the first target interface.

In a possible implementation, the terminal may call the first target interface to send an online programmed target program to the machine equipment. The machine equipment may execute the target program after receiving the target program. A student performing online programming may determine whether the target program is programmed correctly by determining whether an actual operation performed by the machine equipment matches an expected operation corresponding to the target program.

In another possible implementation, the student may also acquire the target program by performing offline programming through a programming client or another application, such as a document editing application (such as a notepad application, a word application, etc.). After the terminal has detected the machine equipment and determined the first target interface, the student may trigger a virtual key preset on a client (such as a browser programming web page end) or another application on a programming terminal, to control the terminal to call the first target interface to send the offline programmed target program to the machine equipment. The machine equipment may receive and then execute the target program, as well.

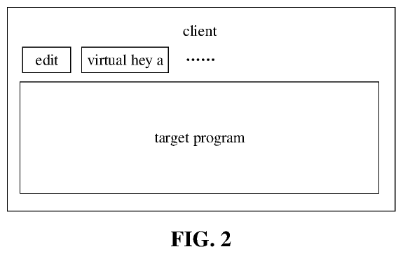

For example, as shown in FIG. 2, a virtual key a is provided in the client in advance. After completing offline programming, the student may trigger the virtual key a. At this time, the terminal may directly call the first target interface to send the target program to the machine equipment.

In the embodiment, the terminal may automatically send the target program to the machine equipment, which simplifies the operation process of sending the target program to the machine equipment, and reduces the manual operation when controlling the machine equipment through the target program.

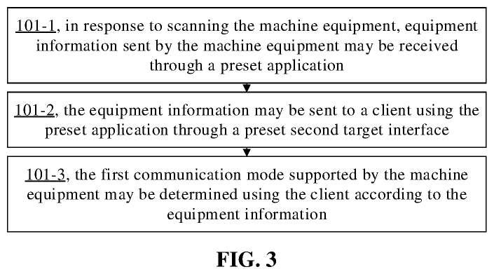

In some optional embodiments, such as shown in FIG. 3, step 101 may include steps as follows. In step 101-1, in response to scanning the machine equipment, equipment information sent by the machine equipment may be received through a preset application.

In some embodiments of the present disclosure, the machine equipment may be connected to the terminal through Bluetooth, a serial port, etc. After detecting the machine equipment, the terminal may receive the equipment information reported by the machine equipment through a preset application.

The preset application may be a preset application configured to provide an abstract interface for communicating with different machine equipment. The equipment information may include the equipment type, manufacturer, equipment identification, etc., of the machine equipment.

In step 101-2, the equipment information may be sent to a client using the preset application through a preset second target interface.

In some embodiments of the present disclosure, the second target interface is a communication interface preset between the preset application and the client. Optionally, the second target interface may support a specified communication mode, such as a Hyper Text Transfer Protocol over Secure Socket Layer (HTTPS), a Web Socket Secure (WSS) protocol, a Hyper Text Transfer Protocol over Socket Layer (HTTP), a Web Socket (WS) protocol, etc. It should be noted that any communication mode supported by a browser may serve as a communication mode supported by the second target interface, and should fall within the protection scope of embodiments of the present disclosure.

A client used for programming may be a browser side for online programming or offline programming, or another application capable of offline programming, such as a document editing application (such as a notepad application, a word application, etc.). The client is a front end presented to the student for performing programming.

In this step, after receiving the equipment information reported by the machine equipment, the preset application may send the equipment information to the client through the second target interface preset between the preset application and the client.

In step 101-3, the first communication mode supported by the machine equipment may be determined using the client according to the equipment information.

In some embodiments of the present disclosure, after receiving the equipment information of the machine equipment sent by the preset application, the client may communicate with a server corresponding to the client by calling an interpreted dynamic scripting language (JS, Java Script) library pre-stored on the client, and sends the equipment information to the server. The server determines the communication mode corresponding to the equipment information sent by the client according to a pre-stored correspondence between equipment information and a communication mode. The client interacts with the server, and determining any one communication mode returned by the server as the first communication mode.

For example, the equipment information indicates that the manufacturer of the machine equipment is a manufacturer a. The client communicates with the server through the JS library. The server pre-stores the correspondence between equipment information and a communication mode. The correspondence pre-stored by the server indicates that machine equipment manufactured by the manufacturer a all adopt the UDP or Web Socket mode. Then, the client may set the UDP or Web Socket mode returned by the server as the first communication mode.

Of course, in other embodiments, the client per se may also determine the first communication mode independent of the server, such as by finding the first communication mode supported by the machine equipment according to the acquired machine equipment information through the pre-stored correspondence between equipment information and a communication mode.

With the embodiment, the first communication mode supported by the machine equipment may be determined quickly, facilitating a subsequent call to a corresponding interface to send an online programmed target program to the machine equipment, rendering high availability.

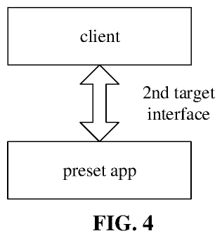

In some optional embodiments, there is a second target interface between the preset application and the client. For example, as shown in FIG. 4, the second target interface may support a second communication mode, such as at least one of HTTPS, WSS, HTTP, and WS.

Optionally, the second communication mode may be different from or the same as the first communication mode supported by the machine equipment, which is not limited by embodiments of the present disclosure.

In the embodiment, the second target interface preset between the preset application and the client supports the second communication mode. The second communication mode and the first communication mode may be the same or different. In this way, even if different machine equipment support different first communication modes, communication between the machine equipment and the client may be implemented through the preset application in the second communication mode, implementing control of equipment with different first communication modes by the terminal.

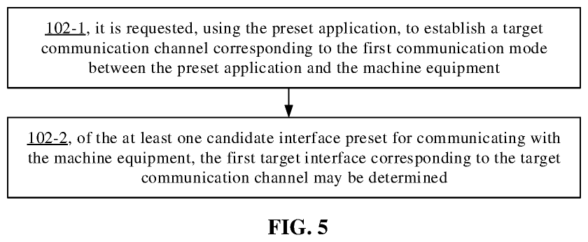

In some optional embodiments, such as shown in FIG. 5, step 102 may include steps as follows. In step 102-1, it is requested, using the preset application, to establish a target communication channel corresponding to the first communication mode between the preset application and the machine equipment.

After the client has determined the first communication mode supported by the machine equipment, the client may notify the preset application of the first communication mode through the second target interface. The preset application may request to establish a target communication channel corresponding to the first communication mode between the preset application and the machine equipment.

For example, if the first communication mode is UDP, the preset application may request to establish a UDP channel, and if the first communication mode is Socket 10, the preset application may request to establish a Socket IO channel.

In step 102-2, of the at least one candidate interface preset for communicating with the machine equipment, the first target interface corresponding to the target communication channel may be determined.

Further, after the target communication channel has been established between the preset application and the machine equipment, the preset application determines, in the at least one candidate interface, the first target interface corresponding to the target communication channel.

In the embodiment, the preset application first requests to establish a target communication channel corresponding to the first communication mode with the machine equipment. The first target interface corresponding to the target communication channel in the at least one candidate interface preset for communicating with the machine equipment is determined, providing a service-independent target communication channel between the client and the machine equipment through the preset application, thereby supporting machine equipment with different first communication modes.

In some optional embodiments, the step 102-2 may include a step as follows.

Of the at least one candidate interface preset for communicating with the machine equipment, an interface that corresponds to the target communication channel and that is configured to send information to the machine equipment may be determined as the first target interface using the preset application.

In some embodiments of the present disclosure, the preset application may determine, in at least one preset candidate interface, an interface corresponding to the target communication channel and configured to send information to the machine equipment as the first target interface.

In the embodiment, a preset application may abstract at least one candidate interface from different first communication modes on the terminal for access by multiple pieces of hardware. The interface corresponding to the target communication channel and configured for sending information to the machine equipment may be determined as the first target interface, which unifies the control operation of the machine equipment supporting different first communication modes, and supports machine equipment with different first communication modes.

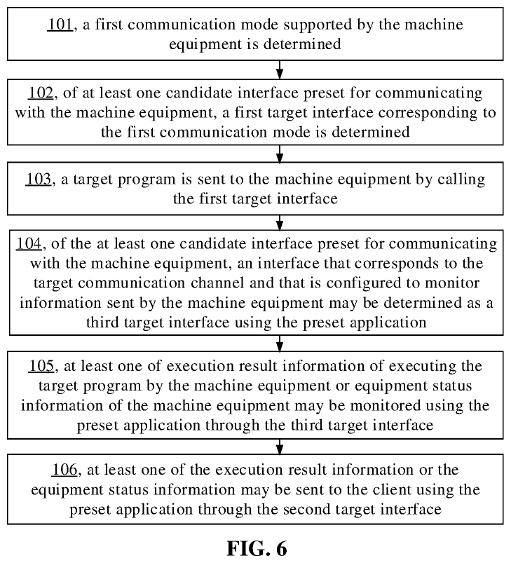

In some optional embodiments, such as shown in FIG. 6, after completing the step 103, the method may further include steps as follows.

In step 104, of the at least one candidate interface preset for communicating with the machine equipment, an interface that corresponds to the target communication channel and that is configured to monitor information sent by the machine equipment may be determined as a third target interface using the preset application.

In some embodiments of the present disclosure, the preset application may also determine, in at least one preset candidate interface, a monitoring interface corresponding to the target communication channel as the third target interface. For example, if the first communication mode is UDP, and an established target communication channel is a UDP channel, a monitoring interface corresponding to the UDP channel and configured for monitoring information sent by the machine equipment to the terminal may be taken as the third target interface.

In step 105, at least one of execution result information of executing the target program by the machine equipment or equipment status information of the machine equipment may be monitored using the preset application through the third target interface.

In some embodiments of the present disclosure, the preset application may monitor, through the third target interface, whether there is information on the result of executing the target program returned by the machine equipment. Optionally, the execution result information may include execution result information during execution of the target program by the machine equipment, and execution result information acquired upon completing execution of the target program.

In addition, the preset application may monitor, through the third target interface, equipment status information reported by the machine equipment. Optionally, the equipment status information may include whether the machine equipment is operating normally, or a reason for an abnormality occurring in the machine equipment.

In step 106, at least one of the execution result information or the equipment status information may be sent to the client using the preset application through the second target interface.

In some embodiments of the present disclosure, the preset application may also send at least one of the execution result information or the equipment status information to the client through the second target interface.

In the embodiment, the preset application may monitor at least one of execution result information of executing the target program or equipment status information of the machine equipment sent by the machine equipment through the third target interface. The preset application may send at least one of the execution result information or the equipment status information to the client through the second target interface, acquiring the execution result information of executing the target program by the machine equipment, determining the equipment status information of the machine equipment.

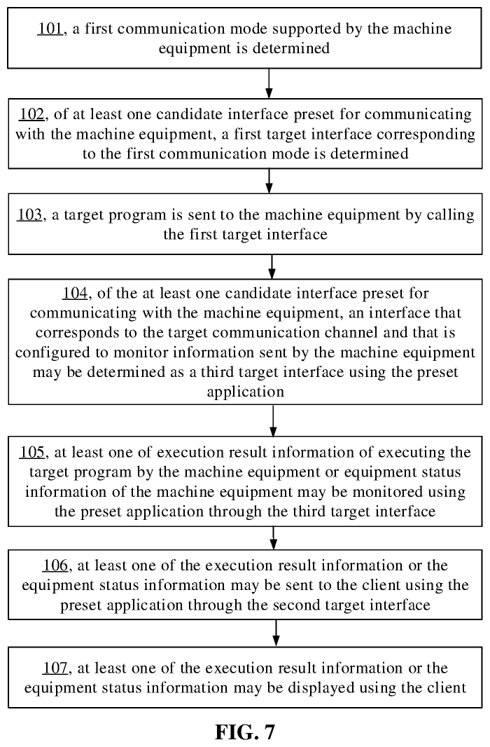

In some optional embodiments, such as shown in FIG. 7, after step 106 has been completed, the method may further include a step as follows.

In step 107, at least one of the execution result information or the equipment status information may be displayed using the client.

After receiving at least one of the execution result information or the equipment status information, the client may display at least one of the execution result information or the equipment status information on a display interface.

In other embodiments, after receiving at least one of the execution result information or the equipment status information, the client may save the received information, and call the display when the user needs to view the information.

In the embodiment, the execution result information is displayed on the client, which helps the student to debug the target program. In addition, the status of the machine equipment may be displayed on the client, which facilitates better control of the machine equipment.

Embodiments of the present disclosure also provide another method for controlling machine equipment, which may be applied to machine equipment. The machine equipment may be electronic equipment that executes an action or operation corresponding to a computer program.

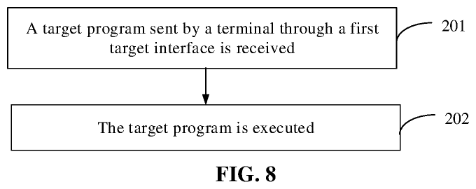

Refer to FIG. 8. FIG. 8 is another method for controlling machine equipment according to an exemplary embodiment. The machine equipment may be a robot that performs an operation corresponding to a computer program, such as a Raspberry Pi (which is a microcomputer designed for computer programming education/learning)/TX2 (TX2 is a computer module), or a robot such as Pocket, or a drone, an unmanned vehicle, etc. The method includes steps as follows.

In step 201, a target program sent by a terminal through a first target interface is received.

In some embodiments of the present disclosure, the preset application on the terminal perform abstraction on first communication modes in which multiple pieces of hardware communicate respectively with different machine equipment, providing at least one candidate interface for communicating with different machine equipment.

The first target interface is a sending interface of the at least one candidate interface, the sending interface being determined by the preset application according to the first communication mode supported by the machine equipment, the sending interface being configured to send information to the machine equipment. The target program may be a program programmed by the student, such as a program edited by the student through an online programming software/client.

In step 202, the target program is executed.

In some embodiments of the present disclosure, the machine equipment may automatically execute the target program, and perform an operation or action corresponding to the target program.

In the embodiment, the machine equipment may directly receive the target program sent by the terminal through the first target interface, thereby executing the target program, which simplifies the operation of acquiring the target program.

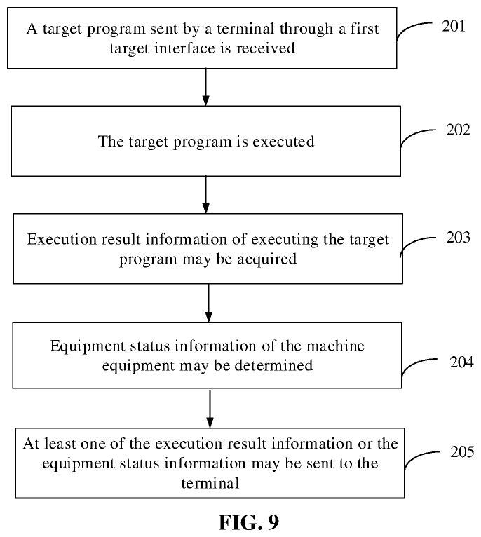

In some optional embodiments, such as shown in FIG. 9, the method may further include steps as follows.

In step 203, execution result information of executing the target program may be acquired.

In some embodiments of the present disclosure, in the process of target program execution, upon execution of a program, the machine equipment may generate execution result information for the program. Moreover, the machine equipment may acquire final execution result information after all target programs have been executed.

In step 204, equipment status information of the machine equipment may be determined.

In some embodiments of the present disclosure, machine equipment may determine, at a preset interval, equipment status information of the machine equipment per se, such as whether the machine equipment per se is operating normally, or if there is an abnormality, the cause of the abnormality. Alternatively, the machine equipment may return equipment status information of the machine equipment per se after or during execution of a program.

In step 205, at least one of the execution result information or the equipment status information may be sent to the terminal.

The machine equipment may send at least one of the execution result information or the equipment status information to the terminal. The preset application of the terminal will perform monitoring through the third target interface. Once at least one of the execution result information or the equipment status information is monitored, the preset application will send at least one of the execution result information or the equipment status information to the client through the second target interface, so that the client may display the information.

In the embodiment, the machine equipment may send at least one of the execution result information of executing the target program by the machine equipment or the equipment status information of the machine equipment per se to the terminal, and the terminal may display the information, so that the student may better debug the target program and control the mechanical equipment.

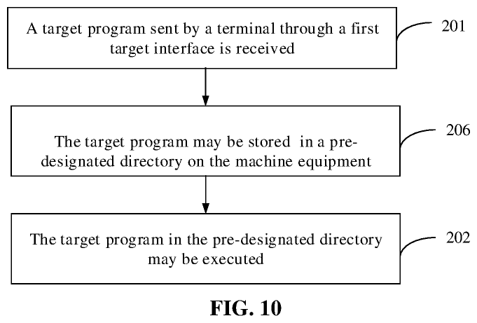

In some optional embodiments, such as shown in FIG. 10, after step 201 has been completed, the method may further include steps as follows.

In step 206, the target program may be stored in a pre-designated directory on the machine equipment.

The machine equipment may automatically store the target program received through the first target interface in a pre-designated directory.

Correspondingly, when step 202 is executed, the machine equipment may execute the target program in the pre-designated directory.

In the embodiment, the machine equipment may automatically store the target program in a pre-designated directory. When the target program is to be executed, the target program in the directory is automatically executed, which improves the degree of intelligence of the machine equipment and simplifies the operation of acquiring the target program.

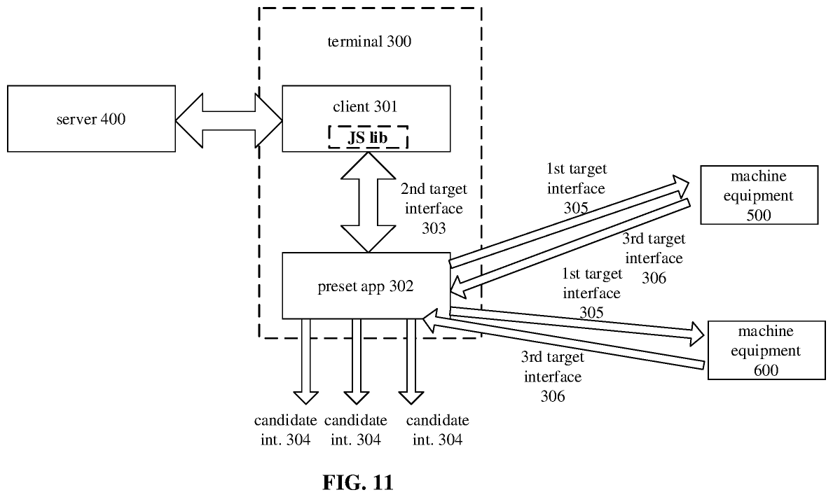

In some optional embodiments, for example, it is as shown in FIG. 11. FIG. 11 is a diagram of a scene of controlling machine equipment.

The terminal 300 includes a client 301, a preset application 302, and a second target interface 303 provided between the client 301 and the preset application 302. The server 400 may provide the client 301 with information required by an online programming interface. The machine equipment 500 and the machine equipment 600 respectively support different first communication modes.

The client 301 may be a front end for a student to perform online programming (such as a browser allowing online programming). The client 301 includes a JS library, and the client 301 may communicate with the server 302 to display the online programming interface.

The preset application 302 may be named as an Agent program, which abstracts at least one candidate interface 304 from different first communication modes for access by multiple pieces of hardware, so as to provide service-independent target communication channels respectively between the client 301 and the machine equipment 500 as well as the machine equipment 600.

The second target interface 303 is set between the client 301 and the preset application 302, and the second target interface 303 may support at least one of communication modes HTTPS, WSS, HTTP, and WS.

When detecting the machine equipment 500, the terminal 300 may receive the equipment information reported by the machine equipment 500 through the preset application 302, and then the preset application 302 may send the equipment information to the client 301 through the second target interface 303.

The client 301 calls the JS library to communicate with the server 400. The server 400 determines the first communication mode supported by the machine equipment 500 according to a pre-stored correspondence between equipment information and a communication mode, and informs the client 301 of the first communication mode. The client 301 informs the preset application 302 of the first communication mode through the second target interface 303.

The preset application 302 requests to establish, between the preset application 302 and the machine equipment 500, a target communication channel corresponding to the first communication mode. After the target communication channel has been established, the preset application 302 takes the sending interface corresponding to the first communication mode supported by the machine equipment 500 in at least one preset candidate interface 304 as the first target interface 305.

The preset application 302 directly calls the first target interface 305 to send the target program to the machine equipment 500.

The machine equipment 500 stores the target program in a pre-designated directory, and then executes the target program. During execution of the target program, the machine equipment 500 may acquire execution result information for an intermediate process as well as execution result information after the execution completes. The machine equipment 500 may automatically determine equipment status information of the machine equipment per se at a preset interval. The machine equipment 500 sends at least one of the execution result information or the equipment status information to the terminal 300.

After monitoring at least one of the execution result information or the equipment status information through the third target interface 306, the preset application 302 sends at least one of the execution result information or the equipment status information to the client 301 through the second target interface 303. The client 301 may display at least one of the execution result information or the equipment status information.

In the embodiment, when the client 301 needs to interact with the machine equipment 500, the preset application 302 only needs to provide an interface corresponding to the first communication mode.

For example, when the first communication mode supported by the machine equipment 500 is UDP, the preset application 302 only needs to provide a UDP interface to implement interaction between the machine equipment 500 and the terminal 300.

The preset application 302 requests a UDP channel, calls the sending interface of the UDP channel (that is, the first target interface 305) to send a UDP message, and sends the target program to the machine equipment 500 through the UDP message. In addition, the preset application 302 may also call the monitoring interface of the UDP channel (i.e., the third target interface 306) to receive a UDP response message sent by the machine equipment 500. The response message may include at least one of the execution result information of the machine equipment 500 executing the target program or the equipment status information of the machine equipment 500. The preset application 302 sends at least one of the execution result information or the equipment status information to the client 301 through the second target interface 303. The client 301 displays the information.

As another example, the first communication mode supported by the machine equipment 600 is WebSocket, and the preset application 302 only needs to provide a WebSocket interface to implement interaction between the machine equipment 600 and the terminal 300.

The preset application 302 requests a WebSocket channel, calls the sending interface of the WebSocket channel (i.e., the first target interface 305) to send a WebSocket message, and sends the target program to the machine equipment 600 through the WebSocket message. In addition, the preset application 302 may also call another interface of the WebSocket channel, such as any one of event interfaces onopen (call event), onclose (close event), onmessage (receiving message), onerror (error), etc., as the corresponding third target interface 306, to receive a WebSocket response message sent by the machine equipment 600. The response message may include at least one of the execution result information of the machine equipment 600 executing the target program or the equipment status information of the machine equipment 600. The preset application 302 sends at least one of the execution result information or the equipment status information to the client 301 through the second target interface 303, and the client 301 displays the information.

In the embodiment, the terminal automatically sends the target program to the machine equipment, which simplifies the operation process of sending the target program to the machine equipment, and reduces the manual operation when controlling the machine equipment through the target program. An application will be preset to provide a target communication channel that is independent of a service, so as to support machine equipment with different first communication modes. In addition, the result of executing the target program is displayed on the client, which helps the student debug the target program, and the status of the machine equipment may be displayed on the client, which helps better control the machine equipment.

Corresponding to the method embodiments, the present disclosure also provides device embodiments.

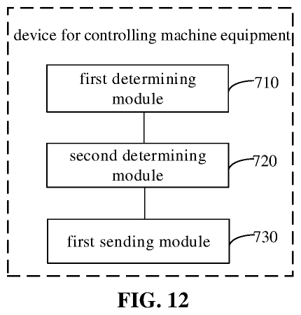

Refer to FIG. 12. FIG. 12 is a block diagram of a device for controlling machine equipment according to an exemplary embodiment of the present disclosure. The device includes: a first determining module 710 configured to determine a first communication mode supported by the machine equipment; a second determining module 720 configured to determine, of at least one candidate interface preset for communicating with the machine equipment, a first target interface corresponding to the first communication mode; and a first sending module 730 configured to send a target program to the machine equipment by calling the first target interface.

In some optional embodiments, the first determining module 710 includes: a receiving sub-module configured to, in response to scanning the machine equipment, receive, through a preset application, equipment information sent by the machine equipment; a sending sub-module configured to send the equipment information to a client using the preset application through a preset second target interface, the second target interface being a communication interface set between the preset application and the client; and a determining sub-module configured to determine the first communication mode supported by the machine equipment using the client according to the equipment information.

In some optional embodiments, the second target interface supports a second communication mode.

In some optional embodiments, the determining sub-module includes: a first determining unit configured to request, using the preset application, to establish a target communication channel corresponding to the first communication mode between the preset application and the machine equipment; and a second determining unit configured to determine, of the at least one candidate interface preset for communicating with the machine equipment, the first target interface corresponding to the target communication channel.

In some optional embodiments, the second determining unit includes: a determining sub-unit is configured to, of the at least one candidate interface preset for communicating with the machine equipment, determine, as the first target interface using the preset application, an interface that corresponds to the target communication channel and that is configured to send information to the machine equipment.

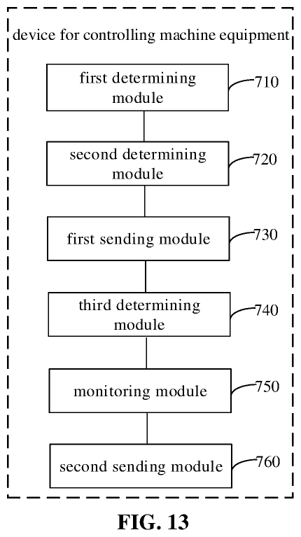

In some optional embodiments, for example, as shown in FIG. 13, the device further includes: a third determining module 740 configured to, of the at least one candidate interface preset for communicating with the machine equipment, determine, as a third target interface using the preset application, an interface that corresponds to the target communication channel and that is configured to monitor information sent by the machine equipment; a monitoring module 750 configured to monitor, using the preset application through the third target interface, at least one of execution result information of executing the target program by the machine equipment or equipment status information of the machine equipment; and a second sending module 760 configured to send, to the client using the preset application through the second target interface, at least one of the execution result information or the equipment status information.

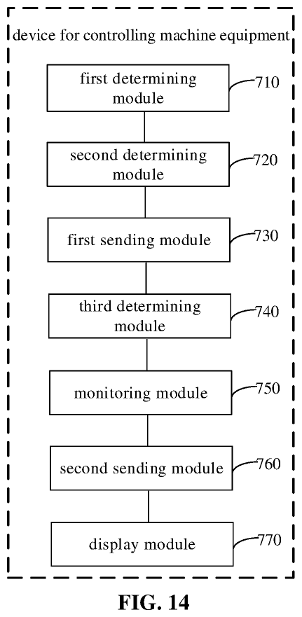

In some optional embodiments, such as shown in FIG. 14, the device further includes: a display module 770 configured to display, using the client, at least one of the execution result information or the equipment status information.

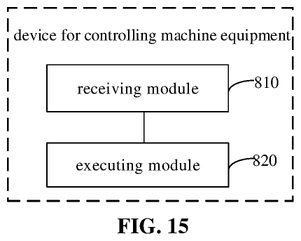

Refer to FIG. 15. FIG. 15 is a block diagram of another device for controlling machine equipment according to an exemplary embodiment of the present disclosure, including: a receiving module 810 configured to receive a target program sent by a terminal through a first target interface, the first target interface being an interface of at least one candidate interface preset for communicating with the machine equipment determined by the terminal according to a first communication mode supported by the machine equipment; and an executing module 820 configured to execute the target program.

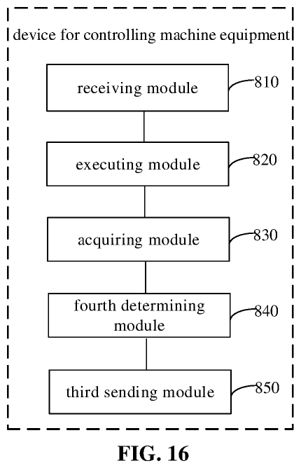

In some optional embodiments, for example, as shown in FIG. 16, the device further includes: an acquiring module 830 configured to acquire execution result information of executing the target program; a fourth determining module 840 configured to determine equipment status information of the machine equipment; and a third sending module 850 configured to send at least one of the execution result information or the equipment status information to the terminal.

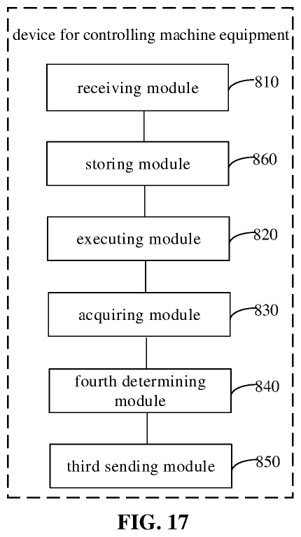

In some optional embodiments, for example, as shown in FIG. 17, the device further includes: a storing module 860 configured to store the target program in a pre-designated directory on the machine equipment. The executing module 820 may include an executing sub-module configured to execute the target program in the pre-designated directory.

A device embodiment herein basically corresponds to a method embodiment herein, description of which may be referred to for a related part thereof. A device embodiment described herein is but schematic. Units described herein as separate parts may or may not be physically separate. A part displayed as a unit may or may not be a physical unit. That is, it may be located in one place, or distributed over multiple network units. Some or all of the modules herein may be selected as needed to achieve an effect of a solution herein. A person having ordinary skill in the art may understand and implement the without creative effort.

Embodiment of the present disclosure also provides a computer-readable storage medium, storing thereon a computer program. The computer program is for executing any forgoing method for controlling machine equipment applied to a terminal side, or for executing any forgoing method for controlling machine equipment applied to machine equipment side. The computer-readable storage medium may be a volatile storage medium or a non-volatile storage medium.

In some optional embodiments, embodiments of the present disclosure provide a computer program product, including a computer-readable code. When the computer-readable code runs on equipment, a processor in the equipment executes instructions for implementing the method for controlling machine equipment provided by any forgoing embodiment.

In some optional embodiments, embodiments of the present disclosure also provide another computer program product for storing computer-readable instructions which, when executed, allow a computer to execute operations of the method for controlling machine equipment provided by any forgoing embodiment.

The computer program product may be specifically implemented by hardware, software or a combination thereof. In an optional embodiment, the computer program product is specifically embodied as a computer storage medium (including volatile and non-volatile storage media). In another optional embodiment, the computer program product is specifically embodied as a software product, such as a Software Development Kit (SDK), etc.

Embodiments of the present disclosure also provide a device for controlling machine equipment, including: a processor; a memory for storing executable instructions executable by a processor. The processor is configured to call the executable instructions stored in the memory to implement any forgoing method for controlling machine equipment at a terminal side, or any forgoing method for controlling machine equipment at machine equipment side.

It may be understood that the memory may be implemented by any type of volatile or non-volatile storage equipment, or a combination thereof. The non-volatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a Flash Memory, a magnetic surface memory, a CD, or a Compact Disc Read-Only Memory (CD-ROM). A magnetic surface memory may be a disk memory or a tape memory. The volatile memory may be a Random Access Memory (RAM), which is used as an external cache. By way of exemplary instead of restrictive description, many forms of RAM are available, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM), a Direct Rambus Random Access Memory (DRRAM). The memory 804 described in embodiments of the present disclosure is intended to include, but is not limited to, these and any other suitable types of memory.

A method herein may be applied to a processor, or implemented by the processor. The processor may be an integrated circuit chip capable of signal processing. In implementation, a step of the method may be carried out via an integrated logic circuit of hardware in the processor or instructions in form of software. The processor may be a general-purpose processor, a Digital Signal Processor (DSP), or another programmable logic device, a discrete gate, or a transistor logic device, a discrete hardware component, etc. The processor may implement or execute various methods, steps, and logical block diagrams herein. A general-purpose processor may be a microprocessor or any conventional processor. A step of the method disclosed herein may be directly embodied as being carried out by a hardware decoding processor, or by a combination of hardware and software modules in the decoding processor. A software module may be located in a storage medium. The storage medium may be located in the memory. The processor may read information in the memory, and combine it with hardware thereof to perform a step of a method herein.

Other implementations of the present disclosure will be apparent to a person having ordinary skill in the art that has considered the specification and practiced the present disclosure. The present disclosure is intended to cover any variation, use, or adaptation of the present disclosure following the general principles of the present disclosure and including such departures from the present disclosure as come within common knowledge or customary practice in the art. The specification and the embodiments are intended to be exemplary only, with a true scope and spirit of the present disclosure being indicated by the appended claims.

What described are merely embodiments of the present disclosure, and are not intended to limit the present disclosure. Any modification, equivalent replacement, improvement, etc., made within the spirit and principle of the present disclosure should be included in the scope of the present disclosure.

1. A method for controlling machine equipment, comprising:
determining a first communication mode supported by the machine equipment;
determining, of at least one candidate interface preset for communicating with the machine equipment, a first target interface corresponding to the first communication mode; and
sending a target program to the machine equipment by calling the first target interface.

2. The method of claim 1, wherein determining the first communication mode supported by the machine equipment comprises:
in response to scanning the machine equipment, receiving, through a preset application, equipment information sent by the machine equipment;
sending the equipment information to a client using the preset application through a preset second target interface, the second target interface being a communication interface set between the preset application and the client; and
determining the first communication mode supported by the machine equipment using the client according to the equipment information.

3. The method of claim 2, wherein the second target interface supports a second communication mode.

4. The method of claim 2, wherein determining, of the at least one candidate interface preset for communicating with the machine equipment, the first target interface corresponding to the first communication mode comprises:
requesting, using the preset application, to establish a target communication channel corresponding to the first communication mode between the preset application and the machine equipment; and
determining, of the at least one candidate interface preset for communicating with the machine equipment, the first target interface corresponding to the target communication channel.

5. The method of claim 4, wherein determining, of the at least one candidate interface preset for communicating with the machine equipment, the first target interface corresponding to the target communication channel comprises:
of the at least one candidate interface preset for communicating with the machine equipment, determining, as the first target interface using the preset application, an interface that corresponds to the target communication channel and that is configured to send information to the machine equipment.

6. The method of claim 4, further comprising: after sending the target program to the machine equipment by calling the first target interface,
of the at least one candidate interface preset for communicating with the machine equipment, determining, as a third target interface using the preset application, an interface that corresponds to the target communication channel and that is configured to monitor information sent by the machine equipment;
monitoring, using the preset application through the third target interface, at least one of execution result information of executing the target program by the machine equipment or equipment status information of the machine equipment; and
sending, to the client using the preset application through the second target interface, at least one of the execution result information or the equipment status information.

7. The method of claim 6, further comprising: after sending, to the client using the preset application through the second target interface, at least one of the execution result information or the equipment status information,
displaying, using the client, at least one of the execution result information or the equipment status information.

8. A method for controlling machine equipment, comprising:
receiving a target program sent by a terminal through a first target interface, the first target interface being an interface of at least one candidate interface preset for communicating with the machine equipment determined by the terminal according to a first communication mode supported by the machine equipment; and
executing the target program.

9. The method of claim 8, further comprising:
acquiring execution result information of executing the target program;
determining equipment status information of the machine equipment; and
sending at least one of the execution result information or the equipment status information to the terminal.

10. The method of claim 8, further comprising: after receiving the target program sent by the terminal through the first target interface,
storing the target program in a pre-designated directory on the machine equipment,
executing the target program comprising:
executing the target program in the pre-designated directory.

11. A device for controlling machine equipment, comprising:
a processor; and
a memory for storing executable instructions executable by the processor,
wherein the processor is configured to call the executable instructions stored in the memory to implement:
determining a first communication mode supported by the machine equipment;
determining, of at least one candidate interface preset for communicating with the machine equipment, a first target interface corresponding to the first communication mode; and
sending a target program to the machine equipment by calling the first target interface.

12. The device of claim 11, wherein the processor is configured to determine the first communication mode supported by the machine equipment by:
in response to scanning the machine equipment, receiving, through a preset application, equipment information sent by the machine equipment;
sending the equipment information to a client using the preset application through a preset second target interface, the second target interface being a communication interface set between the preset application and the client; and
determining the first communication mode supported by the machine equipment using the client according to the equipment information.

13. The device of claim 12, wherein the second target interface supports a second communication mode.

14. The device of claim 12, wherein the processor is configured to determine, of the at least one candidate interface preset for communicating with the machine equipment, the first target interface corresponding to the first communication mode, by:
requesting, using the preset application, to establish a target communication channel corresponding to the first communication mode between the preset application and the machine equipment; and
determining, of the at least one candidate interface preset for communicating with the machine equipment, the first target interface corresponding to the target communication channel.

15. The device of claim 14, wherein the processor is configured to determine, of the at least one candidate interface preset for communicating with the machine equipment, the first target interface corresponding to the target communication channel, by:
of the at least one candidate interface preset for communicating with the machine equipment, determining, as the first target interface using the preset application, an interface that corresponds to the target communication channel and that is configured to send information to the machine equipment.

16. The device of claim 14, wherein the processor is further configured to implement: after sending the target program to the machine equipment by calling the first target interface,
of the at least one candidate interface preset for communicating with the machine equipment, determining, as a third target interface using the preset application, an interface that corresponds to the target communication channel and that is configured to monitor information sent by the machine equipment;
monitoring, using the preset application through the third target interface, at least one of execution result information of executing the target program by the machine equipment or equipment status information of the machine equipment; and
sending, to the client using the preset application through the second target interface, at least one of the execution result information or the equipment status information.

17. The device of claim 16, wherein the processor is further configured to implement: after sending, to the client using the preset application through the second target interface, at least one of the execution result information or the equipment status information,
displaying, using the client, at least one of the execution result information or the equipment status information.

18. A device for controlling machine equipment, comprising:
a processor; and
a memory for storing executable instructions executable by the processor,
wherein the processor is configured to call the executable instructions stored in the memory to implement the method of claim 8.

19. The device of claim 18, wherein the processor is further configured to implement:
acquiring execution result information of executing the target program;
determining equipment status information of the machine equipment; and
sending at least one of the execution result information or the equipment status information to the terminal.

20. A non-transitory computer-readable storage medium, having stored thereon a computer program for implementing the method of claim 1.
